(19) United States
(12) Patent Application Publication
(10) Pub. No.: US 2022/0083206 A1
(43) Pub. Date: Mar. 17, 2022

(54) DEVICE AND METHOD FOR CREATING INTERACTIVE EMOTICONS

(71) Applicant: BEMILY, INC., Gyeonggi-do (KR)

(72) Inventors: Sung Chan PARK, Seoul (KR); Yang Woo LEE, Gyeonggi-do (KR); Hyung Min SHIN, Gyeonggi-do (KR); Kil Sang YU, Seoul (KR); Joo Yun JUNG, Seoul (KR); Yun Dong PARK, Seoul (KR); Won SEO, Gyeonggi-do (KR); Do Hoon KIM, Seoul (KR); Jin Woo KIM, Gyeonggi-do (KR); Myeong Yun SEONG, Gyeonggi-do (KR); Byeong Joo KIM, Seoul (KR); Dong Wook MIN, Seoul (KR); Min Jae KIM, Gyeonggi-do (KR)

(73) Assignee: BEMILY, INC., Gyeonggi-do (KR)

(21) Appl. No.: 17/172,828

(22) Filed: Feb. 10, 2021

(30) Foreign Application Priority Data
Sep. 17, 2020 (KR) 10-2020-0120045

(51) Int. Cl. G06F 3/0484; H04L 12/58; G06F 3/0481; H04M 1/72436

(52) U.S. Cl. CPC G06F 3/04842; H04L 51/10; H04M 1/72436; G06F 3/04845; G06F 3/04817

(57) ABSTRACT

A method of creating an interactive emoticon includes receiving a selected basic emoticon, receiving input user text, displaying a preview of an interactive emoticon to be transmitted based on the selected basic emoticon and the input user text, and forming the interactive emoticon based on the selected basic emoticon and the input user text, wherein the displaying of a preview of an interactive emoticon includes performing a font size change or a line break based on a number of characters of the input user text.

### CROSS-REFERENCE TO RELATED APPLICATION

This application claims priority to and the benefit of Korean Patent Application No. 10-2020-0120045, filed on Sep. 17, 2020, the disclosure of which is incorporated herein by reference in its entirety.

### FIELD

The present disclosure relates to a device and method for creating interactive emoticons, and more particularly, to a device and method for transmitting and receiving an interactive emoticon through a messenger installed on a mobile phone, personal computer (PC), or the like.

### BACKGROUND

The statements in this section merely provide background information related to the present disclosure and may not constitute prior art.

Recently, the distribution rate of smartphones is very high around the world, and mobile messengers are preferred over short message service (SMS) in terms of communication between acquaintances. Thus, a social networking service (SNS), a mobile platform service, and the like are actively being implemented based on the mobile messengers. In particular, emoticons that are used in chatting (conversation) using mobile messengers are effectively used to express emotions that are difficult to convey with text alone.

Meanwhile, emoticons are serviced in the creator sector, focusing on localization rather than technical attempts due to unique characters, facial expressions, movements, and native characters. Also, among elements of an emoticon, native characters are pointed out as an obstacle to global service expansion.

Korean Patent No. 10-2112584 discloses a method of creating a processed emoticon, but this method is inconvenient in that users should manually select a font type, a font size, etc. of the text.

### SUMMARY

This section provides a general summary of the disclosure and is not a comprehensive disclosure of its full scope or all of its features.

The present disclosure is directed to providing an interactive emoticon creation device and method that may be widely used in various countries regardless of language type.

The present disclosure is directed to providing an interactive emoticon creation device and method that may automatically determine an interactive emoticon to be formed by text input by a user.

The present disclosure is directed to providing an interactive emoticon creation device and method that can minimize the time it takes to transmit or receive an interactive emoticon to or from other devices.

According to an aspect of the present disclosure, a method of creating an interactive emoticon includes receiving a selected basic emoticon, receiving input user text, displaying a preview of an interactive emoticon to be transmitted based on the selected basic emoticon and the input user text, and forming the interactive emoticon based on the selected basic emoticon and the input user text, wherein the displaying of a preview of an interactive emoticon includes performing a font size change or a line break based on a number of characters of the input user text.

In one aspect, the performing of the font size change or the line break may include changing a font size of the input user text to a first size when the number of characters of the input user text is greater than or equal to a first number, and changing the font size of the input user text to a second size when the number of characters of the input user text is greater than or equal to a second number, where the second number is greater than the first number, and where the second size is smaller than the first size.

In one aspect, the displaying of the preview of the interactive emoticon may include resizing the selected basic emoticon based on the number of characters.

In one aspect, the displaying of the preview of the interactive emoticon may include displaying the input user text in a speech balloon placed near the selected basic emoticon.

In one aspect, the method may further include receiving a selected speech balloon style, wherein the speech is changed based on the selected speech balloon style.

In one aspect, the receiving of the input user text may include displaying the input user text inputted by an input unit in a text input window, and the preview of the interactive emoticon to be transmitted may include the input user text displayed in the text input window.

In one aspect, the present disclosure includes a computer program stored in a recording medium and configured to execute the interactive emoticon creation method described herein.

According to another aspect of the present disclosure, a method for creating an interactive emoticon includes receiving a user input including a basic emoticon and user text, determining a number of characters of the user text, selectively adjusting parameters of the basic emoticon and the user text based on the number of characters, wherein adjusting the parameters comprises at least one of a font size change operation, a line break operation, and an emoticon size change operation, generating instructions for forming an interactive emoticon based on the selectively adjusted parameters of at least one of the basic emoticon and the user text, and transmitting the instructions to a remote device.

In one aspect, the font size change operation further includes changing a font size of the user text to a first size when the number of characters is greater than a first threshold value and less than a second threshold value, and changing the font size of the user text to a second size when the number of characters is greater than the first threshold value and greater than the second threshold value, where the second size is smaller than the first size.

In one aspect, the line break operation further comprises inserting a line break in the user text when the number of characters is greater than a threshold value.

In one aspect, the emoticon size change operation further comprises reducing a size of the basic emoticon when the number of characters is greater than a threshold value.

In one aspect, the method further includes displaying a preview of the interactive emoticon based on the selectively adjusted parameters of at least one of the basic emoticon and the user text.

According to another aspect of the present disclosure, a device for creating an interactive emoticon includes an input unit configured to receive a selected basic emoticon and input user text, a display unit configured to display a preview of an interactive emoticon to be transmitted based on the input user text, and a control unit configured to create the interactive emoticon based on the selected basic emoticon and the input user text, wherein the control unit performs a font size change or a line break based on a number of characters of the input user text.

In one aspect, the control unit is configured to change a font size to a first size of the input user text when the number of characters of the input user text is greater than or equal to a first number, and change the font size of the input user text to a second size when the number of characters of the input user text is greater than or equal to a second number greater than the first number, where the second number is greater than the first number, and where the second size is smaller than the first size.

In one aspect, the control unit is configured to resize the selected basic emoticon based on the number of characters of the input user text.

In one aspect, the control unit is configured to control the display unit to display the input user text in a speech balloon placed near the selected basic emoticon.

In one aspect, the input unit is configured to receive a selected speech balloon style, and the control unit is configured to change a speech balloon based on the selected speech balloon style.

In one aspect, the control unit is configured to control the display unit to display user text inputted by the input unit in a text input window, and the preview of the interactive emoticon to be transmitted may include the input user text displayed in the text input window.

In one aspect, when the selected basic emoticon type and the input user text are received, the control unit is configured to create and display the interactive emoticon based on the selected basic emotion type and the input user text.

In one aspect, the device may further include a storage unit configured to store information on an interactive emoticon to be created based on a type of basic emoticon and the number of characters in the input user text, where the control unit is configured to transmit the type of the selected basic emoticon and the input user text.

### DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram showing interactive emoticon creation devices according to an embodiment of the present disclosure;

FIG. 2 is a block diagram showing an interactive emoticon creation device 100 or 200 according to an embodiment of the present disclosure;

FIG. 3 is a flowchart showing a method of operating an interactive emoticon creation device according to an embodiment of the present disclosure;

FIG. 4 is an example diagram illustrating a method of receiving an input for selecting a basic emoticon according to an embodiment of the present disclosure;

FIG. 5 is an example diagram illustrating a method of receiving a text input according to an embodiment of the present disclosure;

FIG. 6A is an example diagram showing a method of an interactive emoticon creation device according to an embodiment of the present disclosure;

FIG. 6B is an example diagram showing a method of an interactive emoticon creation device automatically performing a line break on the basis of user text according to an embodiment of the present disclosure;

FIG. 6C is an example diagram showing a method of an interactive emoticon creation device automatically performing a font size change and a line break operation on the basis of user text according to an embodiment of the present disclosure;

FIG. 7 is an example diagram showing a method of an interactive emotion creation device receiving a selected speech balloon style according to an embodiment of the present disclosure;

FIG. 8 is an example diagram showing a method of an interactive emotion creation device forming an interactive emoticon according to an embodiment of the present disclosure; and

FIG. 9 is an example diagram showing an aspect in which an interactive emotion creation device forms an interactive emoticon irrespective of language according to an embodiment of the present disclosure.

### DETAILED DESCRIPTION

Advantages and features of the present disclosure, and implementation methods thereof will be clarified through the following embodiments described in detail with reference to the accompanying drawings. However, the present disclosure is not limited to the embodiments disclosed below and may be implemented in various forms. The exemplary embodiments are provided only for completing the disclosure of the present disclosure and for fully representing the scope of the present disclosure to those skilled in the art.

In the following description, the detailed description of the relevant known functions or configurations will be omitted except when the description is used to describe embodiments of the present disclosure. Also, terms used herein are defined in consideration of the functions of embodiments of the present disclosure and may be changed depending on a user, the intent of an operator, or a custom. Therefore, the definitions should be made based on the contents throughout the disclosure.

Functional blocks shown in the drawings and described below are just examples of possible implementations. In other implementations, other functional blocks may be used without departing from the spirit and scope of the detailed description. Also, while one or more functional blocks of the present disclosure are represented as individual blocks, one or more of the functional blocks of the present disclosure may be a combination of various hardware and software elements that perform the same function.

Also, the expression “include some elements” is open-ended and simply refers to the presence of the corresponding elements. Therefore, it should not be understood that this expression excludes additional elements.

When it is mentioned that a certain element is coupled to or connected to another element, it should be understood that the certain element may be directly coupled or connected to the other element or that still another element may be located therebetween.

Also, the terms “first,” “second,” etc. are used to distinguish a plurality of elements and do not limit the order or other features between the elements.

Hereinafter, embodiments of the present disclosure will be described with reference to the accompanying drawings.

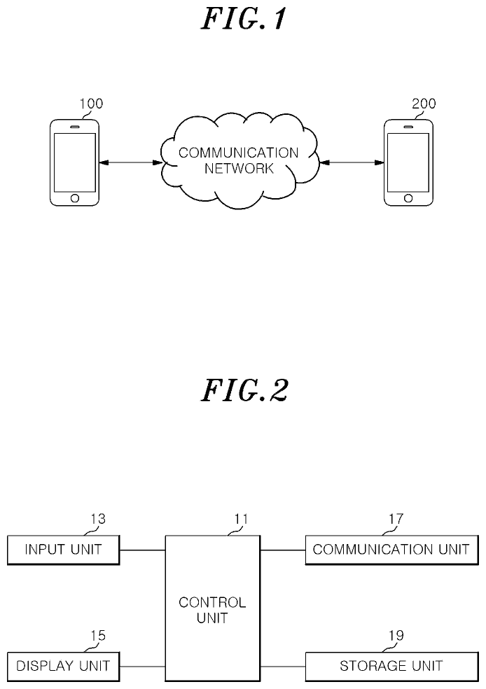

FIG. 1 is a diagram showing interactive emoticon creation devices according to an embodiment of the present disclosure.

In FIG. 1, first and second interactive emoticon creation devices 100 and 200 are shown, but this is just an example for explanation, and various numbers of interactive emoticon creation devices may transmit or receive interactive emoticons.

Referring to FIG. 1, a first interactive emoticon creation device 100 (interchangeably referred to as messenger 100 herein) and a second interactive emoticon creation device 200 may be operatively connected to each other over a network to transmit or receive information. For example, the network may include wired or wireless communication networks, such as a local area network (LAN), a wide area network (WAN), a virtual network, and a remote communication network.

The first interactive emoticon creation device 100 may transmit an interactive emoticon to a second interactive emoticon creation device 200, and the second interactive emoticon creation device 200 may receive an interactive emoticon from the first interactive emoticon creation device 100. Alternatively, the second interactive emoticon creation device 200 may transmit an interactive emoticon to the first interactive emoticon creation device 100, and the first interactive emoticon creation device 100 may receive an interactive emoticon from the second interactive emoticon creation device 200.

The first interactive emoticon creation device 100 and the second interactive emoticon creation device 200 may be implemented as various types of devices configured to transmit or receive information over a network. For example, the devices may include a portable communication device (e.g., a smartphone), a computer device, a portable multimedia device, a notebook computer, a tablet PC, and the like.

FIG. 2 is a block diagram showing the interactive emoticon creation device 100 or 200 according to an embodiment of the present disclosure.

The interactive emoticon creation device may include at least some or all of a control unit 11, an input unit 13, a display unit 15, a communication unit 17, and a storage unit 19.

The control unit 11 may control the overall operation of the interactive emoticon creation device. The control unit 11 may individually control the input unit 13, the display unit 15, the communication unit 17, and the storage unit 19.

The input unit 13 may be implemented with at least one of a predetermined physical key or a touch key.

The control unit 11 may receive a text input, an emoticon selection input, etc. through the input unit 13.

The display unit 15 may form and display an interactive emoticon according to input text and a selected basic emoticon.

The communication unit 17 may include a communication module for wired or wireless communication with other interactive emoticon creation devices.

The control unit 11 may transmit at least one of text information and basic emoticon information to other interactive emoticon creation devices through the communication unit 17. Alternatively, the control unit 11 may receive at least one of text information and basic emoticon information for interactive emoticon formation through the communication unit 17 and may form and display an interactive emoticon using the received text information and basic emoticon information.

Generally, the interactive emoticon creation device is implemented in a form in which application software is installed on a handheld-based general-purpose wireless communication device, such as a smartphone, a smartpad, and a tablet PC, which guarantees portability and mobility. Alternatively, the interactive emoticon creation device may be implemented through a computer capable of accessing a website. It should be understood that the present disclosure is not limited to the example emoticon creation devices and can be implemented by any device in which application software can be installed and executed.

The storage unit 19 may store information necessary for standardization of an interactive emoticon to be formed.

Specifically, the storage unit 19 may store information of an interactive emoticon to be formed according to the type of the basic emoticon and the number of characters in the user text.

As an example, based on the information stored in the storage unit 19, the control unit 11 may form an interactive emoticon with a font size of 15 when the basic emoticon is “A” and the number of characters in the user text is 10 and may form an interactive emoticon with a font size of 10 when the basic emoticon is “A” and the number of characters in the user text is 20.

Meanwhile, the control unit 11, the input unit 13, the display unit 15, the communication unit 17, and the storage unit 19, which are included in the above-described embodiment, may be implemented by a memory including instructions programmed to perform their functions and a computing device including a microprocessor for performing the instructions.

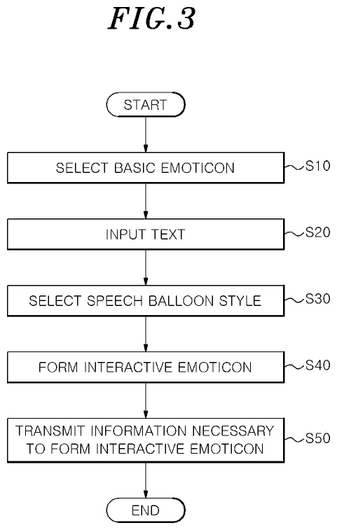

FIG. 3 is a flowchart showing a method of operating an interactive emoticon creation device according to an embodiment of the present disclosure.

The control unit 11 may receive an input for selecting a basic emoticon through the input unit 13 (S10).

A basic emoticon may refer to an emoticon to be used to form an interactive emoticon.

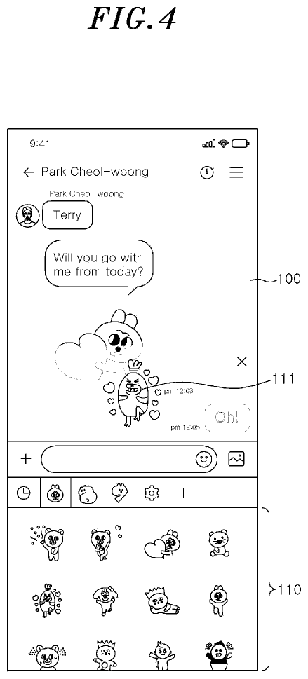

FIG. 4 is an example diagram illustrating a method of receiving an input for selecting a basic emoticon according to an embodiment of the present disclosure.

As shown in FIG. 4, the display unit 15 may display a basic emoticon type 110 on a messenger 100. The basic emoticon type 110 may include one or more types. The control unit 11 may receive an input for selecting a basic emoticon by receiving a selected one of the basic emoticon types 110. The display unit 15 may display a selected basic emoticon 111 on the messenger 100.

The description of FIG. 3 will be resumed.

The control unit 11 may receive a text input through the input unit 13 (S20).

The text input may be user text which a user has input such that the user text is included in an interactive emoticon.

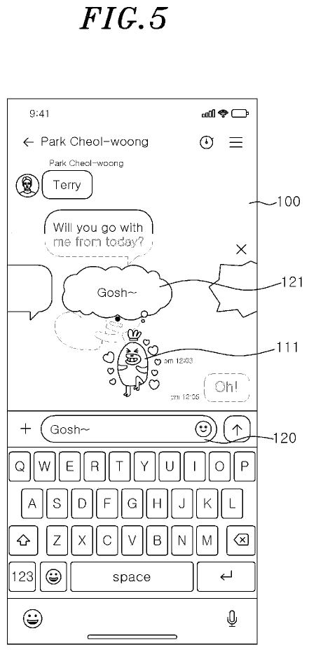

For example and as shown in FIG. 5, which is an example diagram illustrating a method of receiving a text input according to an embodiment of the present disclosure, the control unit 11 may display the input user text 121 in a speech balloon placed near the selected basic emoticon 111.

The input unit 13 may receive a text input through a text input window 120 of the messenger 100. The user text input through the input unit 13 may be displayed in the text input window 120.

The display unit 15 may display the user text 121 input through the text input window 120 in addition to the selected basic emoticon 111. Accordingly, a preview of an interactive emoticon to be transmitted may include user text displayed in the text input window 120. Accordingly, a user may input text through the text input window 120 on the messenger 100, and the input user text may be displayed in the preview of the interactive emoticon. That is, a user does not input text through the preview of the interactive emoticon, and thus conveniently, a user does not have to manually set the position, size, and the like of the text.

In this case, a font size change, a font type change, and a line break may be automatically performed on the user text 121.

In some embodiments, the order of operations S10 and S20 may be changed.

That is, the control unit 11 receives a basic emoticon and user text regardless of the order and displays the preview of the interactive emoticon to be transmitted when the basic emoticon and the user text are input. In this case, a font size change, a font type change, and a line break may be automatically performed according to the number of characters in the user text.

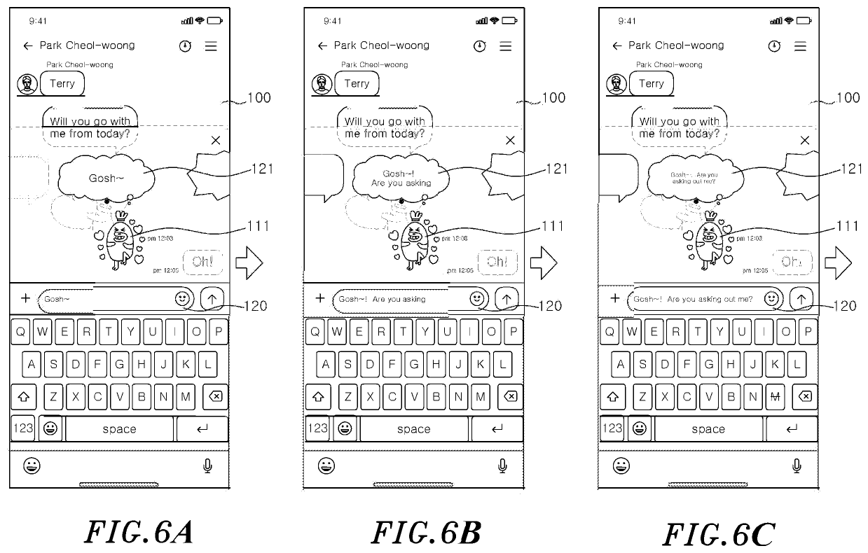

Next, FIGS. 6A-6C are example diagrams showing a method of an interactive emoticon creation device automatically performing a font size change and/or a line break on the basis of user text according to an embodiment of the present disclosure.

As shown in the example of FIGS. 6A-6C, the control unit 11 may perform a font size change such that the font size of the user text 121 decreases as the number of characters in the text input through the text input window 120 increases. For example, the control unit 11 may change the font size to a first size when the number of characters is greater than or equal to a first number and may change the font size to a second size smaller than the first size when the number of characters is greater than or equal to a second number greater than the first number.

In some embodiments and as shown in FIG. 6C, the control unit 11 may perform a line break of the user text 121 each time the number of characters in text input through the text input window 120 exceeds a preset number of characters.

In some embodiments, the control unit 11 may resize the selected basic emoticon. For example, when the number of characters in the user text exceeds a preset maximum number of characters, the control unit 11 may display the preview of the interactive emoticon by reducing the size of the basic emoticon. Thus, it is possible to prevent a user who receives an interactive emoticon from being unable to recognize user text due to the font size of the user text being too small.

The description of FIG. 3 will be resumed.

The control unit 11 may receive an input for selecting a speech balloon style through the input unit 13 (S30).

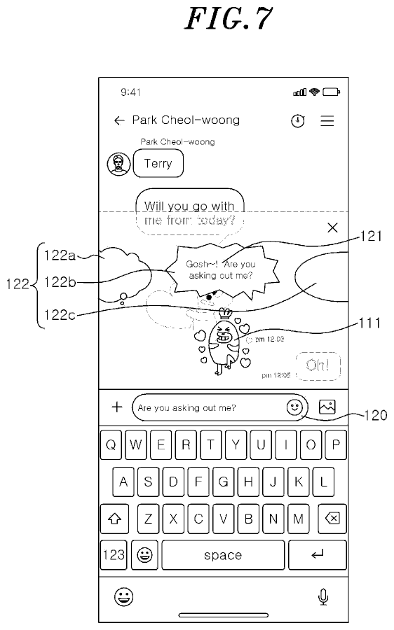

FIG. 7 is an example diagram showing a method of an interactive emotion creation device receiving a selected speech balloon style according to an embodiment of the present disclosure.

As shown in FIG. 7, the display unit 15 may display a speech balloon style type 122. The control unit 11 may receive an input for selecting a speech balloon style by receiving an input for selecting one of a plurality of speech balloon style types 122a, 122b, and 122c.

According to the selected speech balloon style, the control unit 11 may display the preview of the interactive emoticon by changing a speech balloon in which input user text is to be displayed.

The description of FIG. 3 will be resumed.

The control unit 11 may form an interactive emoticon (S40).

The control unit 11 may form the interactive emoticon according to a selected basic emoticon and input user text. In detail, the control unit 11 may calculate the position and size of the emoticon, the position and size of the user text, and the like according to user text and a basic emoticon selected based on the information stored in the storage unit 19.

The control unit 11 may transmit the information necessary to form the interactive emoticon to other interactive emoticon creation devices.

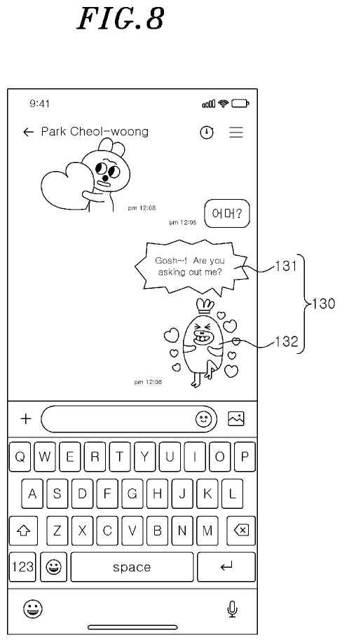

FIG. 8 is an example diagram showing a method of an interactive emotion creation device forming an interactive emoticon according to an embodiment of the present disclosure.

The control unit 11 may form an interactive emoticon 130 by combining user text 131 and a selected basic emoticon 132 and display the formed interactive emoticon 130.

Meanwhile, when transmitting the interactive emoticon, the control unit 11 may transmit the selected basic emoticon type and the user text rather than transmitting an image of the interactive emoticon.

Thus, when an interactive emoticon creation device receives an interactive emoticon, the interactive emoticon creation device may receive a basic emoticon type and user text instead of receiving the interactive emoticon in an image format and may create and display the interactive emoticon on the basis of the received emoticon type and the received user text.

As described above, according to an embodiment of the present disclosure, a text to be combined into an emoticon is input by a user. Therefore, it is possible to transmit and receive an interactive emoticon that may be used by people in various countries regardless of language type, etc., and thus it is possible to standardize interactive emoticons (i.e., make the interactive emoticons universal).

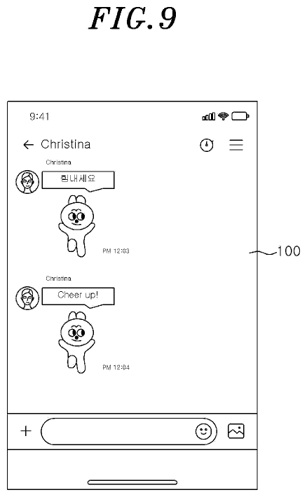

FIG. 9 is an example diagram showing an aspect in which an interactive emotion creation device forms an interactive emoticon irrespective of language according to an embodiment of the present disclosure.

Also, according to the present disclosure, an interactive emoticon to be formed is automatically determined by text input by a user, and thus it is possible to provide the user with the convenience of not having to manually select a font type, a font size, an emoticon size, and so on.

Also, according to an embodiment of the present disclosure, the information necessary to form an interactive emoticon rather than the interactive emoticon itself is transmitted. Thus, it is possible to save data and minimize the time it takes to transmit or receive an interactive emoticon.

The above-described embodiments of the present disclosure may be implemented through various computing system components. For example, the embodiments of the present disclosure may be implemented by hardware, firmware, software, or a combination thereof.

In the case of implementation by hardware, a method according to embodiments of the present disclosure may be implemented by one or more application-specific integrated circuits (ASICs), digital signal processors (DSPs), digital signal processing devices (DSPDs), programmable logic devices (PLDs), field-programmable gate arrays (FPGAs), processors, controllers, microcontrollers, microprocessors, and the like.

In the case of implementation by firmware or software, a method according to the embodiments of the present disclosure may be implemented in the form of a module, procedure, or function that performs the above-described functions or operations. A computer program in which software code and the like are recorded may be stored in a computer-readable recording medium or a memory unit and driven by a processor. The memory unit may be placed inside or outside the processor and may exchange data with the processor through various known communication protocols.

Also, combinations of respective blocks of the accompanying block diagram and combinations of respective steps of the accompanying flowchart may be performed by computer program instructions. Since these computer program instructions may be provided to an encoding processor of a general-purpose computer, special purpose computer, or other programmable data processing apparatuses, it is possible to create a computing system for implementing the functions/acts specified in the flowchart and/or block diagram block or blocks such that the instructions are executed via the encoding processor of the computer or other programmable data processing apparatuses. These computer program instructions may also be stored in a computer-readable storage medium that can direct a computer, a programmable data processing apparatus, and/or other devices to function in a particular manner, such that the instructions stored in the computer-readable storage medium can produce an article of manufacture including an instruction for implementing aspects of the function/act specified in the flowchart and/or block diagram block or blocks. The computer program instructions may also be loaded onto a computer, other programmable data processing apparatuses, or other devices to cause a series of operational steps to be performed on the computer, other programmable apparatuses or other devices to produce a computer implemented process, such that the instructions which are executed on the computer, other programmable apparatuses, or other devices implement the functions/acts specified in the flowchart and/or block diagram block or blocks.

In addition, each block or step described herein may indicate a portion of a module, segment, or code including one or more executable instructions for executing a specific logical function. It should also be noted that, in some alternative implementations, the functions mentioned in the blocks or steps may occur out of the order described in the figure. For example, two blocks or steps shown in succession may, in fact, be executed substantially concurrently, or may sometimes be executed in reverse order, depending upon the functionality involved.

According to the present disclosure, it is possible to transmit or receive interactive emoticons that may be used by people in various countries regardless of language type or the like, and thus it is possible to standardize interactive emoticons (i.e., make the interactive emoticons universal).

According to the present disclosure, an interactive emoticon to be formed is automatically determined by text input by a user, and thus it is possible to provide the user with the convenience of not having to manually select a font type, a font size, an emoticon size, and so on.

According to the present disclosure, an interactive emoticon is transmitted to other devices not in an image format but in a text format, and thus it is possible to save data and minimize the time it takes to transmit or receive an interactive emoticon.

It will be understood by those skilled in the art that the present disclosure can be implemented in other specific forms without changing the technical spirit or features of the present disclosure. Accordingly, the above-described embodiments should be regarded as illustrative rather than restrictive. Therefore, the scope of the present disclosure is defined not by the detailed description but by the following claims, and all changes or modifications within the claims and their equivalents will be construed as being included in the scope of the present disclosure.

What is claimed is:

1. A method of creating an interactive emoticon, the method comprising:
receiving a selected basic emoticon;
receiving input user text;
displaying a preview of the interactive emoticon to be transmitted based on the selected basic emoticon and the input user text; and
forming the interactive emoticon based on the selected basic emoticon and the input user text,
wherein the displaying of the preview of the interactive emoticon comprises performing a font size change or a line break based on a number of characters of the input user text.

2. The method of claim 1, wherein the performing of the font size change or the line break further comprises:
changing a font size of the input user text to a first size when the number of characters of the input user text is greater than or equal to a first number; and
changing the font size of the input user text to a second size when the number of characters of the input user text is greater than or equal to a second number,
wherein the second number is greater than the first number, and
wherein the second size is smaller than the first size.

3. The method of claim 1, wherein the displaying of the preview of the interactive emoticon further comprises resizing the selected basic emoticon based on the number of characters.

4. The method of claim 1, wherein the displaying of the preview of the interactive emoticon further comprises displaying the input user text in a speech balloon placed near the selected basic emoticon.

5. The method of claim 4, further comprising receiving a selected speech balloon style, wherein the speech balloon is changed based on the selected speech balloon style.

6. The method of claim 1, wherein:
the receiving of the input user text further comprises displaying the input user text inputted by an input unit in a text input window, and
the preview of the interactive emoticon to be transmitted further includes the input user text displayed in the text input window.

7. A computer program stored in a recording medium and configured to

1. the interactive emoticon creation method of claim 1.

8. A method comprising:
receiving a user input including a basic emoticon and user text;
determining a number of characters of the user text;
selectively adjusting parameters of the basic emoticon and the user text based on the number of characters, wherein adjusting the parameters comprises at least one of a font size change operation, a line break operation, and an emoticon size change operation;
generating instructions for forming an interactive emoticon based on the selectively adjusted parameters of at least one of the basic emoticon and the user text; and
transmitting the instructions to a remote device.

9. The method of claim 8, wherein the font size change operation further comprises:
changing a font size of the user text to a first size when the number of characters is greater than a first threshold value and less than a second threshold value; and
changing the font size of the user text to a second size when the number of characters is greater than the first threshold value and greater than the second threshold value, wherein the second size is smaller than the first size.

10. The method of claim 8, wherein the line break operation further comprises inserting a line break in the user text when the number of characters is greater than a threshold value.

11. The method of claim 8, wherein the emoticon size change operation further comprises reducing a size of the basic emoticon when the number of characters is greater than a threshold value.

12. The method of claim 8 further comprising displaying a preview of the interactive emoticon based on the selectively adjusted parameters of at least one of the basic emoticon and the user text.

13. A device for creating an interactive emoticon, the device comprising:
an input unit configured to receive a selected basic emoticon and input user text;
a display unit configured to display a preview of the interactive emoticon to be transmitted based on the input user text; and
a control unit configured to create the interactive emoticon based on the selected basic emoticon and the input user text,
wherein the control unit performs a font size change or a line break based on a number of characters of the input user text.

14. The device of claim 13, wherein the control unit is configured to:
change a font size of the input user text to a first size when the number of characters of the input user text is greater than or equal to a first number; and
change the font size of the input user text to a second size when the number of characters of the input user text is greater than or equal to a second number,
wherein the second number is greater than the first number, and
wherein the second size is smaller than the first size.

15. The device of claim 13, wherein the control unit is configured to resize the selected basic emoticon based on the number of characters of the input user text.

16. The device of claim 13, wherein the control unit is configured to control the display unit to display the input user text in a speech balloon placed near the selected basic emoticon.

17. The device of claim 16, wherein:
the input unit is configured to receive a selected speech balloon style, and
the control unit is configured to change a speech balloon based on the selected speech balloon style.

18. The device of claim 13, wherein
the control unit is configured to control the display unit to display the input user text inputted by the input unit in a text input window, and
the preview of the interactive emoticon to be transmitted further includes the input user text displayed in the text input window.

19. The device of claim 18, wherein when the selected basic emoticon type and the input user text are received, the control unit is configured to create and display the interactive emoticon based on the selected basic emotion type and the input user text.

20. The device of claim 13, further comprising a storage unit configured to store information on an interactive emoticon to be created based on a type of selected basic emoticon and the number of characters in the input user text,
wherein the control unit is configured to transmit the type of selected basic emoticon and the input user text.
